(19) United States
(12) Patent Application Publication
(10) Pub. No.: US 2014/0336086 A1
(43) Pub. Date: Nov. 13, 2014

(54) VISCOSIFIERS FOR DRILLING FLUIDS

(71) Applicant: Galata Chemicals LLC, Southbury, CT (US)

(72) Inventor: Peter Frenkel, Danbury, CT (US)

(73) Assignee: Galata Chemicals LLC, Southbury, CT (US)

(21) Appl. No.: 14/260,159

(22) Filed: Apr. 23, 2014

Related U.S. Application Data
(60) Provisional application No. 61/821,575, filed on May 9, 2013.

(51) Int. Cl. C09K 8/035

(52) U.S. Cl. CPC C09K 8/035; C09K 2208/00
USPC 507/136

(57) ABSTRACT

A drilling fluid comprising 0.1 to 50% by weight of at least one viscosifier selected from epoxidized fatty acid esters, wherein the fatty acid of the fatty acid ester is derived from natural oils or animal fats, and the fatty acid is substantially fully esterified with monohydric or polyhydric alcohols or mixtures thereof.

### FIELD OF THE INVENTION

The invention relates to drilling fluid compositions containing epoxidized fatty acid ester viscosifiers, a process for adding the viscosifier to a drilling fluid, and a process for drilling wellbores using the drilling fluid.

### BACKGROUND OF THE INVENTION

Drilling fluids have long been used in the exploration for oil and natural gas. These fluids serve a variety of purposes in the drilling of the well, e.g., transporting cuttings from the wellbore to the surface, cooling and cleaning the drill bit, lubricating the drill bit and drill string, and stabilizing the wellbore. The physical properties and flow characteristics of the drilling fluid are designed to meet an array of operability requirements.

Several different types of drilling fluids are used. Water-based fluids have long been utilized, however, problems can arise with water-based fluids when the formation being drilled contains material that interacts with water to cause caving-in or slumping of the well walls. As an alternative, oil-based fluids have been used to avoid wellbore/water interactions. These work well, however, while in the past off-shore drilling operations routinely disposed of cuttings carried by the drilling fluid in the ocean, in the 1990's environmental regulations were enacted which had the effect of prohibiting such disposal. The oil-based fluids were not easily degraded biologically and were harmful to marine life. This required expensive further processing, e.g., transferring the material to shore for disposal.

To maintain the excellent operability of oil-based drilling fluids while avoiding their environmental liabilities, synthetic-based fluids were developed. These biodegradable fluids are based on esters, ethers, polyalphaolefins and olefin isomers, and provide excellent operability, as well as meeting environmental regulations related to the disposal of cuttings in the ocean. Work has been ongoing in the development of improved drilling fluid compositions.

U.S. Pat. No. 5,318,954 relates to drilling fluids and drilling mud compositions comprising an ester oil of a C₁-C₅ monocarboxylic acid and a mono or poly-functional alcohol having at least 8 carbon atoms of flash point above 80° C.

U.S. Patent Re 36,066 relates to an invert emulsion drilling mud free of mineral oil, and consisting of a continuous phase composed predominantly of at least one mono-carboxylic acid ester of C₂-C₁₂ mono-functional alcohols The monocarboxylic acid contains from 16 to 24 carbons and is olefinically mono- and poly-unsaturated

U.S. Pat. No. 7,485,602 relates to a drilling fluid comprising an invert emulsion wherein the continuous phase comprises a blend of isomerized olefins and paraffin hydrocarbons blended with esters.

U.S. Pat. No. 7,231,796 relates to a biodegradable fluid system containing a blend of a C₁-C₄ ester of lactic acid, such as ethyl lactate, and a C₁-C₄ ester of a C₁₆-C₂₀ fatty acid ester.

U.S. Pat. No. 7,392,844 relates to a biodegradable microemulsion system having a discontinuous phase of a blend of C₁-C₄ esters of C₁₆-C₂₀ fatty acids and an emulsifier.

J. Surfact Deterg, 14:131-138 (2011) relates to epoxidized oils loaded at 5% to form stable oil-in-water emulsions in the presence of ester-type surfactants.

U.S. Pat. No. 7,579,306 relates to lubricating fluids, such as hydraulic fluids, comprising an epoxidized tall oil ester.

U.S. Pat. No. 6,448,206 and U.S. Pat. No. 6,503,870 relate to epoxy resin-based compositions for sealing a subterranean zone penetrated by a well bore.

U.S. Pat. No. 7,786,053 and U.S. Pat. No. 7,825,071 relate to a wellbore fluid containing a solid phase coated with a polymer that is the reaction product of a polyesteramide and a crosslinking agent. The crosslinking agent comprises at least one of an epoxidized oil, epoxidized 1,6-hexanediol, aziridine derivatives, epoxy functionalized polyalkalene glycol, an oxidized starch, a polymeric dialdehyde, an aldehyde adduct, a tetra-methoxy propane, and a hydrolyzed acetal.

U.S. Pat. No. 5,278,203 relates to the use of natural and synthetic polymers as viscosifers of aqueous solutions.

U.S. Pat. No. 5,278,203 relates to the use of a suspending agent in combination with a gelling agent and surfactant for formulating drilling fluids.

U.S. Pat. No. 7,858,561 relates to a fracturing fluid carrying with it a proppant (e.g. sand, bauxite, etc.) transported into the formation fracture to create a high permeability path, which prevents complete closure of a newly opened rock formation once the pressure gradient is reversed for production.

U.S. Patent Application Publication No. 2011/0056752 relates to aqueous-based wellbore fluids containing at least one natural polymer monomer and at least one latex monomer for preventing wellbore fluid loss downhole.

U.S. Patent Application Publication No. 2012/0090846 relates to modified polysaccharides used as treatment fluids in the oil and gas field.

U.S. Patent Application Publication No. 2006/0234873 relates to a method for increasing the thermal stability of an aqueous wellbore fluid that includes a viscosifying agent.

U.S. Pat. No. 6,281,172 relates to water-based drilling fluid compositions containing at least one viscosity builder and at least one rheological control agent.

Nevertheless, a continuing need exists for drilling compositions that are sufficiently biodegradable to meet stringent environmental regulations, while also providing excellent operability, including superior viscosity characteristics.

### SUMMARY OF THE INVENTION

In one embodiment, the current invention relates to a drilling fluid comprising 0.1 to 50% by weight of at least one viscosifier selected from epoxidized fatty acid esters, wherein the fatty acid of the fatty acid ester is derived from natural oils or animal fats, and the fatty acid is substantially fully esterified with monohydric or polyhydric alcohols or mixtures thereof.

In another embodiment, the current invention relates to a process comprising adding at least one viscosifier to a drilling fluid in an amount of 0.1 to 50% by weight based on the weight of the drilling fluid, the at least one viscosifier being selected from epoxidized fatty acid esters, wherein the fatty acid of the fatty acid ester is derived from natural oils or animal fats, and the fatty acid is substantially fully esterified with monohydric or polyhydric alcohols or mixtures thereof.

In still another embodiment, the current invention relates to a process comprising drilling a wellbore in a subterranean formation wherein a drilling fluid is added to the wellbore, the drilling fluid comprising 0.1 to 50% by weight of at least one viscosifier selected from epoxidized fatty acid esters, wherein the fatty acid of the fatty acid ester is derived from natural oils or animal fats, and the fatty acid is substantially fully esterified with a monohydric or polyhydric alcohols or mixtures thereof.

### DETAILED DESCRIPTION OF THE INVENTION

Drilling fluids of the invention comprise 0.1 to 50% by weight of at least one viscosifier selected from epoxidized fatty acid esters, wherein the fatty acid of the fatty acid ester is derived from natural oils or animal fats, and the fatty acid is substantially fully esterified with monohydric or polyhydric alcohols or mixtures thereof.

### Viscosifier

The viscosifier controls the viscosity and changes in viscosity of the drilling fluid. This viscosity control is particularly important because often a subterranean formation consists of sections having temperatures significantly higher than the surface temperature. Thus, a drilling fluid may undergo temperature variations of from nearly freezing to that of boiling water or higher during the course of its transit from the well surface to the drill bit and back. Without viscosity control, undesirable viscosity changes in the drilling fluid could take place resulting from the changes in temperature.

When the viscosifier is an epoxidized fatty acid ester where the fatty acid of the fatty acid ester is derived from natural oils, the natural oils are selected from soybean oil, palm oil, olive oil, tall oil, castor oil, cotton seed oil, linseed oil, safflower oil, sunflower oil, canola oil, rapeseed oil, jatropha oil, algae oil, corn oil, tung oil, or mixtures thereof. For the purposes of this specification, the term “derived from” means obtained via epoxidation, or trans-esterification followed by epoxidation, or esterification followed by epoxidation, or epoxidation followed by trans-esterification, or epoxidation followed by esterification; such processes being well known to those skilled in the art.

Preferably, the natural oils are selected from soybean oil, linseed oil, canola oil, tall oil or mixtures thereof.

When the fatty acid is derived from animal fats, the animal fats are selected from beef, mutton, pork, dairy, poultry fat or mixtures thereof. Preferably, the animal fats are selected from suet, tallow, lard, bacon, fatback, butter, poultry fat, schmaltz, blubber or mixtures thereof.

Preferably, the fatty acids derived from natural oils or animal fats are substantially fully esterified with monohydric alcohols or polyhydric alcohols. For the purpose of this specification, the term substantially fully esterified means that the resulting ester content is about 90% or greater.

When the fatty acids are esterified with a monohydric alcohol, the monohydric alcohol is selected from methanol, ethanol, n-propanol, isopropanol, butanol, pentanol, hexanol, cyclohexanol, octanol, n-octanol, iso-octanol, 2-ethylhexanol, nonanol, neodecanol, decanol, undecanol, dodecanol, tetradecanol, cetyl alcohol, stearyl alcohol, docosanol, epoxidized prop-2-3n-1-ol or mixtures thereof. Preferably, the monohydric alcohols are selected from methanol, ethanol, 2-ethylhexanol and iso-octanol.

When the fatty acids are esterified with a polyhydric alcohol, the polyhydric alcohol is selected from glycols, glycerols, glycerol mono-acetate, pentaerythritol or mixtures thereof. Preferably, the polyhydric alcohol is selected from glycerol, ethylene glycol, diethylene glycol, and propylene glycol.

Preferably, the fatty acids, whether derived from natural oils or animal fats, contain unsaturation. Preferably, unsaturated fatty acids are oleic acid, linoleic acid or linolenic acid.

Preferably, the epoxidized fatty acid ester is an epoxidized fatty acid mono-ester, epoxidized fatty acid di-ester, epoxidized fatty acid triglyceride or a mixture thereof, and is preferably selected from epoxidized 2-ethylhexyl tallate, epoxidized 2-ethylhexyl soyate, epoxidized octyl tallate, epoxidized octyl soyate, epoxidized octyl oleate, epoxidized methyl soyate, epoxidized ethyl soyate, epoxidized soybean oil, epoxidized linseed oil, epoxidized propylene glycol dioleate, epoxidized ethylene glycol dioleate, epoxidized ethylene glycol disoyate, epoxidized propylene glycol disoyate or mixtures thereof. More preferably, the epoxidized fatty acid ester is selected from epoxidized 2-ethylhexyl tallate, epoxidized 2-ethylhexyl soyate, epoxidized soybean oil, or mixtures thereof. Even more preferably, the epoxidized fatty acid ester is selected from epoxidized soybean oil, epoxidized 2-ethylhexyl soyate and mixtures thereof. Most preferably, the epoxidized fatty acid ester is epoxidized soybean oil.

The epoxidized ester viscosifier of the invention suitable for use in drilling fluids is typically present in an amount from 0.1 to 50.0 wt % based on the weight of the drilling fluid. Preferably, the viscosifier is present in an amount from 10.0 to 20.0 wt % based on the weight of the drilling fluid.

### Drilling Fluid

The drilling fluid is used to maintain well control and remove drill cuttings from the wellbore. The drilling fluid can be water-based, oil-based (i.e., diesel or mineral oil), based on a synthetic fluid, or combinations thereof. Preferably, the drilling fluid is a synthetic fluid selected from non-epoxidized esters, ethers, polyalphaolefins, olefin isomers, or combinations thereof. Preferably, the synthetic fluid is a non-epoxidized ester. More preferably, the synthetic fluid is a non-epoxidized fatty acid ester. When the drilling fluid is a non-epoxidized fatty acid ester, it is preferably selected from 2-ethylhexyl tallate, 2-ethylhexyl soyate, octyl tallate, octyl soyate, octyl oleate, methyl soyate, ethyl soyate, soybean oil, linseed oil or mixtures thereof. The ratio of the epoxidized fatty acid ester viscosifier to the non-epoxidized ester is typically 0.003 to 2.93; preferably, the ratio is 0.326 to 0.733.

The drilling fluid can also contain surfactants; materials used to increase the density of the fluid, typically referred to as “weight material;” gelling materials such as polyanionic carboxymethylcellulose; chemically modified starches; bentonite; sepiolite; anionic high-molecular weight polymers and biopolymers; thinners such as lignosulfonates, modiilhosulfonates, polyphosphates, tannins, and low molecular weight polyacrylates; shale inhibition agents; shale encapsulation agents such as polyamides and glycols; lubricants; penetration rate enhancers; defoamers; corrosion inhibitors; and loss circulation products. The drilling fluid can also contain emulsifiers, filter control agents, cementing fluids, fracturing fluids, packer fluids, annulus fluids, and similar fluids which are utilized in the drilling and production of oil and gas from subterranean wells. The drilling fluid can further contain viscosifying agents in addition to the viscosifier described herein. For example, the drilling fluid may include starch, schleroglucans, guar gums, polyacrylates, xanthan gum, as well as combinations of these compounds.

In another embodiment, the current invention relates to a process comprising adding at least one viscosifier to a drilling fluid in an amount of 0.1 to 50% by weight based on the weight of the drilling fluid, the at least one viscosifier being selected from epoxidized fatty acid esters, wherein the fatty acid of the fatty acid ester is derived from natural oils or animal fats, and the fatty acid is substantially fully esterified with monohydric or polyhydric alcohols or mixtures thereof.

The viscosifier can be added directly to the drilling fluid in the wellbore, or mixed with the drilling fluid or other carrier fluids outside of the wellbore, and then added to the wellbore. Such an addition can be made using techniques well known to those having skill in the art, for example, by pumping, pressuring or manual addition. The epoxidized fatty acid esters used as the viscosifier are as described above.

In still another embodiment, the current invention relates to a process comprising drilling a wellbore in a subterranean formation wherein a drilling fluid is added to the wellbore, the drilling fluid comprising 0.1 to 50% by weight of at least one viscosifier selected from epoxidized fatty acid esters, wherein the fatty acid of the fatty acid ester is derived from natural oils or animal fats, and the fatty acid is substantially fully esterified with monohydric or polyhydric alcohols or mixtures thereof.

The size and configuration of the wellbore can be any well known to those skilled in the art; e.g., horizontal, vertical, slanted, short radius, medium radius, long radius, S-turn, etc. One skilled in the art would recognize that in the drilling operation the drilling fluid is pumped from a reservoir through a drill string out through a drill bit. Cuttings generated by the drill bit are carried by the drilling fluid up to the wellbore inlet, where they are separated from the drilling fluid. The filtered drilling fluid is then returned to the reservoir. The epoxidized fatty acid esters used as the viscosifier are as described above.

The following Examples further detail preparation of the inventive viscosifier-containing drilling fluid compositions. These examples merely illustrate the invention. Those skilled in the art will recognize many variations that are within the spirit of the invention and scope of the claims.

### EXAMPLES

Fann 35 rheology profiles of ester-based drilling fluids were run at 50° C. immediately after their preparation and then again after hot-rolling for 16 hours at 125° C. Methyl soyate was chosen as the synthetic ester fluid. Epoxidized fatty acid esters, such as epoxidized soybean oil and epoxidized 2-ethylhexyl soyate (manufactured by Galata Chemicals and marketed as Drapex 6.8 and Drapex 5.2, respectively) and their blends were evaluated as viscosifiers.

The Fann 35 Rheology Profiles were determined at 50° C. and ambient pressure, using a Fann Instruments Fann 35 Rotational Viscometer equipped with a F1.0 spring. The Fann 35 dial readings were recorded at 600 rpm, 200 rpm, 100 rpm, 6 rpm, and 3 rpm. The highest dial reading measured at 3 rpm after 10 seconds and 10 minutes were recorded as the 10 second and 10 minute gel strengths. The yield point (YP), apparent viscosity (AV) and plastic viscosity (PV) were calculated using the 600 rpm and 300 rpm dial readings.

The ester-based drilling fluids were first prepared using the compounds and procedures of Table 1. The drilling fluid was then aged for 16 hours at 125° C. in an autoclave in a roller oven to determine the effect of temperature on the stability of the emulsion. The viscosity value was then measured at 50° C.

TABLE 1

| | Amount | | |
|---|---|---|---|
| Material | Added | | Procedure |
| Ester: methyl soyate | 210 | milliliters | Add 210 milliliters of |
| | | | ester oil to the |
| | | | mixing container |
| Saturated aqueous solution | 58.2 | grams | Slowly add saturated |
| of calcium chloride | | | CaCl₂ to the |
| | | | ester oil and mix |
| | | | for 10 minutes |
| INVERMUL ® | 6 | grams | Slowly add INVERMUL |
| | | | and let mix for |
| | | | 5 minutes |
| EZ MUL ® | 3 | grams | Slowly add EZ MUL and |
| | | | let mix for 5 minutes |
| Lime | 1 | gram | Slowly add lime and let |
| | | | mix for 5 minutes |
| DURATONE ® HT | 13 | grams | Slowly add DURATONE |
| | | | HT and let mix for |
| | | | 5 minutes |
| GELTONE ® II | 6 | grams | Slowly add |
| | | | GELTONE ® II and let |
| | | | mix for 5 minutes |
| Barite | 270 | grams | Slowly add Barite |
| | | | and let mix for |
| | | | 30 minutes |

INVERMUL ®—primary emulsifier available from HALLIBURTON
EZ MUL ®—secondary emulsifier and oil-wetting agent available from HALLIBURTON
DURATONE ® HT—modified lignitic filtration control agent available from HALLIBURTON
GELTONE ® II—organophillic clay viscosifier available from HALLIBURTON

### Example 1

### Control

The rheological characteristics of an ester-based (methyl soyate) drilling fluid before and after hot-rolling are summarized in Table 2.

TABLE 2

| | | | | | | | | 10-sec | 10-min | | Yield |
|---|---|---|---|---|---|---|---|---|---|---|---|
| | Viscosity (cP) at rpm | | | | | | | gel, | gel, | Plastic | Point, |
| | 3 | 6 | 100 | 200 | 300 | 600 | AV, | lb/100 | lb/100 | Viscosity, | lb/100 |
| | rpm | rpm | rpm | rpm | rpm | rpm | cP | sq ft | sq ft | cP | sq ft |
| MS BHR | 4 | 5 | 20 | 35 | 45 | 83 | 42 | 11 | 12 | 38 | 7 |
| MS AHR | 30 | 32 | 52 | 67 | 79 | 112 | 56 | 32 | 33 | 33 | 46 |

MS—methyl soyate based drilling fluid
BHR—before hot rolling
AHR—after hot rolling
AV (apparent viscosity), cP = [600 rpm reading]/2
PV (Plastic Viscosity), cP = [600 rpm reading] − [300 rpm reading]
YP (Yield Point), lbs/100 sq ft = [300 rpm reading] (cP) − PV (cP)

### Example 2

The rheological characteristics of an ester-based (methyl soyate) drilling fluid before and after hot-rolling with an epoxidized soybean oil viscosifier loaded at 10% by weight are summarized in Table 3.

TABLE 3

| | | | | | | | | 10-sec | 10-min | | Yield |
|---|---|---|---|---|---|---|---|---|---|---|---|
| | Viscosity (cP) at rpm | | | | | | | gel, | gel, | Plastic | Point, |
| | 3 | 6 | 100 | 200 | 300 | 600 | AV, | lb/100 | lb/100 | Viscosity, | lb/100 |
| | rpm | rpm | rpm | rpm | rpm | rpm | cP | sq ft | sq ft | cP | sq ft. |
| 10/90 | 23 | 24 | 42 | 56 | 68 | 101 | 51 | 23 | 26 | 33 | 35 |
| ESBO/ | | | | | | | | | | | |
| MS BHR | | | | | | | | | | | |
| 10/90 | 16 | 16 | 33 | 47 | 59 | 96 | 48 | 13 | 15 | 34 | 22 |
| ESBO/ | | | | | | | | | | | |
| MS AHR | | | | | | | | | | | |

ESBO—epoxidized soybean oil

Compared with the control Example 1, the ester-based drilling fluid of Example 2 containing 10% ESBO was unexpectedly shown to: (1) increase 10-sec. and 10-min. gel strength before hot-rolling from 11 and 12, to 23 and 26 lb/100 sq ft, respectively; (2) increase AV before hot-rolling from 42 to 51 cP; (3) increase YP before hot-rolling from 7 to 35 lb/100 sq ft; and (4) increase viscosities before hot-rolling within the tested rpm range.

### Example 3

The rheological characteristics of an ester-based (methyl soyate) drilling fluid before and after hot-rolling with an epoxidized soybean oil viscosifier loaded at 17% by weight, is summarized in Table 4.

TABLE 4

| | | | | | | | | 10-sec | 10-min | | Yield |
|---|---|---|---|---|---|---|---|---|---|---|---|
| | Viscosity (cP) at rpm | | | | | | | gel, | gel, | Plastic | Point, |
| | 3 | 6 | 100 | 200 | 300 | 600 | AV, | lb/100 | lb/100 | Viscosity, | lb/100 |
| | rpm | rpm | rpm | rpm | rpm | rpm | cP | sq ft | sq ft | cP | sq ft |
| 17/83 | 25 | 26 | 48 | 65 | 81 | 122 | 61 | 24 | 26 | 41 | 40 |
| ESBO/ | | | | | | | | | | | |
| MS BHR | | | | | | | | | | | |
| 17/83 | 16 | 18 | 49 | 74 | 97 | 160 | 80 | 16 | 18 | 63 | 34 |
| ESBO/ | | | | | | | | | | | |
| MS AHR | | | | | | | | | | | |

Compared with the control Example 1, the ester-based drilling fluid of Example 3 containing 17% ESBO was unexpectedly shown to: (1) increase 10-sec. and 10-min. gel strength before hot-rolling from 11 and 12, to 24 and 26 lb/100 sq ft, respectively; (2) increase AV before hot-rolling from 42 to 61 cP and after hot-rolling from 56 to 80 cP; (3) increase YP before hot-rolling from 7 to 40 lb/100 sq ft; and (4) increase viscosities before hot-rolling within the tested rpm range and after hot-rolling within the range of 200-600 rpm.

### Example 4

The rheological characteristics of an ester-based (methyl soyate) drilling fluid before and after hot-rolling with an epoxidized 2-ethylhexyl soyate viscosifier is summarized in Table 5.

TABLE 5

| | | | | | | | | 10-sec | 10-min | | Yield |
|---|---|---|---|---|---|---|---|---|---|---|---|
| | Viscosity (cP) at rpm | | | | | | | gel, | gel, | Plastic | Point, |
| | 3 | 6 | 100 | 200 | 300 | 600 | AV, | lb/100 | lb/100 | Viscosity, | lb/100 |
| | rpm | rpm | rpm | rpm | rpm | rpm | cP | sq ft | sq ft | cP | sq ft |
| 20/80 | 27 | 27 | 31 | 43 | 55 | 85 | 43 | 15 | 18 | 30 | 25 |
| EEHS/ | | | | | | | | | | | |
| MS BHR | | | | | | | | | | | |
| 20/80 | 20 | 22 | 48 | 69 | 87 | 134 | 67 | 19 | 27 | 47 | 40 |
| EEHS/ | | | | | | | | | | | |
| MS AHR | | | | | | | | | | | |

EEHS—epoxidized 2-ethylhexyl soyate

Compared with the control Example 1, the ester-based drilling fluid of Example 4 containing 20% EEHS was unexpectedly shown to: (1) increase 10-sec. and 10-min. gel strength before hot-rolling from 11 and 12, to 15 and 18 lb/100 sq ft, respectively; (2) increase AV after hot-rolling from 56 to 67 cP; (3) increase YP before hot-rolling from 7 to 25 lb/100 sq ft; and (4) increase viscosities before hot-rolling within the tested rpm range and after hot-rolling within the range of 200-600 rpm.

### Example 5

The rheological characteristics of an ester-based (methyl soyate) drilling fluid before and after hot-rolling with a viscosifier blend of an epoxidized soybean oil and epoxidized 2-ethylhexyl soyate are summarized in Table 6.

TABLE 6

| | | | | | | | | 10-sec | 10-min | | Yield |
|---|---|---|---|---|---|---|---|---|---|---|---|
| | Viscosity, cP | | | | | | | gel, | gel, | Plastic | Point, |
| | 3 | 6 | 100 | 200 | 300 | 600 | AV, | lb/100 | lb/100 | Viscosity, | lb/100 |
| | rpm | rpm | rpm | rpm | rpm | rpm | cP | sq ft | sq ft | cP | sq ft |
| 10/10/80 | 17 | 18 | 36 | 51 | 64 | 98 | 49 | 18 | 19 | 34 | 30 |
| ESBO/EEHS/ | | | | | | | | | | | |
| MS BHR | | | | | | | | | | | |
| 10/10/80 | 18 | 19 | 38 | 54 | 70 | 114 | 57 | 15 | 18 | 44 | 26 |
| ESBO/EEHS/ | | | | | | | | | | | |
| MS AHR | | | | | | | | | | | |

Compared with the control Example 1, the ester-based drilling fluid of Example 5 containing a blend of ESBO and EEHS was unexpectedly shown to: (1) increase 10-sec. and 10-min. gel strength before hot-rolling from 11 and 12, to 18 and 19 lb/100 sq ft, respectively; (2) increase AV before hot-rolling from 42 to 49 cP; (3) increase YP before hot-rolling from 7 to 30 lb/100 sq ft; and (4) increase viscosities before hot-rolling within the tested rpm range.

The above examples demonstrate that in the presence of viscosifiers containing epoxidized fatty acid esters, the main viscosity characteristics of the drilling fluid are increased and better maintained both before and after exposure to high temperatures, relative to fluids not containing the viscosifier.

Other features, advantages and embodiments of the invention disclosed herein will be readily apparent to those exercising ordinary skill after reading the foregoing disclosure. In this regard, while specific embodiments of the invention have been described in considerable detail, variations and modifications of these embodiments can be effected without departing from the spirit and scope of the invention as described and claimed. cm We claim:

1. A drilling fluid comprising 0.1 to 50% by weight of at least one viscosifier selected from epoxidized fatty acid esters, wherein the fatty acid of the fatty acid ester is derived from natural oils or animal fats, and the fatty acid is substantially fully esterified with monohydric or polyhydric alcohols or mixtures thereof.

2. The drilling fluid of claim 1 wherein the at least one viscosifier is an epoxidized fatty acid ester wherein the fatty acid is derived from natural oils.

3. The drilling fluid of claim 2 wherein the natural oils are selected from soybean oil, palm oil, olive oil, tall oil, castor oil, cotton seed oil, linseed oil, safflower oil, sunflower oil, canola oil, rapeseed oil, jatropha oil, algae oil, corn oil, tung oil, or mixtures thereof.

4. The drilling fluid of claim 3 wherein the natural oils are selected from soybean oil, linseed oil, canola oil, tall oil or mixtures thereof.

5. The drilling fluid of claim 1, wherein the at least one viscosifier is an epoxidized fatty acid ester, and the fatty acid is derived from animal fats selected from beef, mutton, pork, dairy, poultry fat or mixtures thereof.

6. The drilling fluid of claim 5, wherein the animal fats are selected from suet, tallow, lard, bacon, fatback, butter, poultry fat, schmaltz, blubber or mixtures thereof.

7. The drilling fluid of claim 1 wherein the fatty acids derived from natural oils or animal fats are substantially fully esterified with monohydric alcohols selected from methanol, ethanol, n-propanol, isopropanol, butanol, pentanol, hexanol, cyclohexanol, octanol, n-octanol, iso-octanol, 2-ethylhexanol, nonanol, neodecanol, decanol, undecanol, dodecanol, tetradecanol, cetyl alcohol, stearyl alcohol, docosanol, epoxidized prop-2-3n−1-ol or mixtures thereof.

8. The drilling fluid of claim 1 wherein the fatty acids derived from natural oils or animal fats are substantially fully esterified with polyhydric alcohols selected from glycols, glycerols, glycerol mono-acetate, pentaerythritol or mixtures thereof.

9. The drilling fluid of claim 1 wherein the fatty acids contain unsaturation.

10. The drilling fluid of claim 9 wherein the unsaturated fatty acids are oleic acid, linoleic acid or linolenic acid.

11. The drilling fluid of claim 1 wherein the epoxidized fatty acid esters are selected from epoxidized 2-ethylhexyl tallate, epoxidized 2-ethylhexyl soyate, epoxidized octyl tallate, epoxidized octyl soyate, epoxidized octyl oleate, epoxidized methyl soyate, epoxidized ethyl soyate, epoxidized soybean oil, epoxidized linseed oil or mixtures thereof.

12. The drilling fluid of claim 11 wherein the epoxidized fatty acid ester is selected from epoxidized methyl soyate, epoxidized 2-ethylhexyl tallate, epoxidized 2-ethylhexyl soyate, or epoxidized soybean oil.

13. The drilling fluid of claim 12 wherein the epoxidized fatty acid ester is epoxidized soybean oil.

14. The drilling fluid of claim 1 wherein the at least one viscosifier is present in an amount from 10.0 to 20.0 wt %.

15. The drilling fluid of claim 1 further comprising at least one non-epoxidized fatty acid ester.

16. The drilling fluid of claim 15 wherein the non-epoxidized fatty acid ester is selected from 2-ethylhexyl tallate, 2-ethylhexyl soyate, octyl tallate, octyl soyate, octyl oleate, methyl soyate, ethyl soyate, soybean oil, linseed oil or mixtures thereof, wherein a ratio epoxidized fatty acid ester/non-epoxidized fatty acid ester is 0.003 to 2.93.

17. The drilling fluid of claim 16 wherein the ratio epoxidized fatty acid ester/non-epoxidized fatty acid ester is 0.326 to 0.733.

18. A process comprising adding at least one viscosifier to a drilling fluid in an amount of 0.1 to 50% by weight based on the weight of the drilling fluid, the at least one viscosifier being selected from epoxidized fatty acid esters, wherein the fatty acid of the fatty acid ester is derived from natural oils or animal fats, and the fatty acid is substantially fully esterified with monohydric or polyhydric alcohols or mixtures thereof.

19. The process of claim 18 wherein the at least one viscosifier is an epoxidized fatty acid ester wherein the fatty acid is derived from natural oils.

20. The process of claim 19 wherein the natural oils are selected from soybean oil, palm oil, olive oil, tall oil, castor oil, cotton seed oil, linseed oil, safflower oil, sunflower oil, canola oil, rapeseed oil, jatropha oil, algae oil, corn oil, tung oil, or mixtures thereof.

21. The process of claim 20 wherein the natural oils are selected from soybean oil, linseed oil, canola oil, tall oil or mixtures thereof.

22. The process of claim 18, wherein the at least one viscosifier is an epoxidized fatty acid ester, and the fatty acid is derived from animal fats selected from beef, mutton, pork, dairy, poultry fat or mixtures thereof.

23. The process of claim 22, wherein the animal fats are selected from suet, tallow, lard, bacon, fatback, butter, poultry fat, schmaltz, blubber or mixtures thereof.

24. The process of claim 18 wherein the fatty acids derived from natural oils or animal fats are substantially fully esterified with monohydric alcohols selected from methanol, ethanol, n-propanol, isopropanol, butanol, pentanol, hexanol, cyclohexanol, octanol, n-octanol, iso-octanol, 2-ethylhexanol, nonanol, neodecanol, decanol, undecanol, dodecanol, tetradecanol, cetyl alcohol, stearyl alcohol, docosanol, epoxidized prop-2-3n−1-ol or mixtures thereof.

25. The process of claim 18 wherein the fatty acids derived from natural oils or animal fats are substantially fully esterified with polyhydric alcohols selected from glycols, glycerols, glycerol mono-acetate, pentaerythritol or mixtures thereof.

26. The process of claim 18 wherein the fatty acids contain unsaturation.

27. The process of claim 26 wherein the unsaturated fatty acids are oleic acid, linoleic acid or linolenic acid.

28. The process of claim 18 wherein the epoxidized fatty acid esters are selected from epoxidized 2-ethylhexyl tallate, epoxidized 2-ethylhexyl soyate, epoxidized octyl tallate, epoxidized octyl soyate, epoxidized octyl oleate, epoxidized methyl soyate, epoxidized ethyl soyate, epoxidized soybean oil, epoxidized linseed oil or mixtures thereof.

29. The process of claim 28 wherein the epoxidized fatty acid ester is selected from epoxidized 2-ethylhexyl tallate, epoxidized 2-ethylhexyl soyate, or epoxidized soybean oil.

30. The process of claim 29 wherein the epoxidized fatty acid ester is epoxidized soybean oil.

31. The process of claim 18 wherein the at least one viscosifier is added in an amount from 10.0 to 20.0 wt % based on the weight of the drilling fluid.

32. The process of claim 18 further comprising at least one non-epoxidized fatty acid ester.

33. The process of claim 32 wherein the non-epoxidized fatty acid ester is selected from 2-ethylhexyl tallate, 2-ethylhexyl soyate, octyl tallate, octyl soyate, octyl oleate, methyl soyate, ethyl soyate, soybean oil, linseed oil or mixtures thereof, wherein a ratio epoxidized fatty acid ester/non-epoxidized fatty acid ester is 0.003 to 2.93.

34. The process of claim 33 wherein the ratio epoxidized fatty acid ester/non-epoxidized fatty acid ester is 0.326 to 0.733.

35. A process comprising drilling a wellbore in a subterranean formation wherein a drilling fluid is added to the wellbore, the drilling fluid comprising 0.1 to 50% by weight of at least one viscosifier selected from epoxidized fatty acid esters, wherein the fatty acid of the fatty acid ester is derived from natural oils or animal fats, and the fatty acid is substantially fully esterified with monohydric or polyhydric alcohols or mixtures thereof.

36. The process of claim 35 wherein the at least one viscosifier is an epoxidized fatty acid ester wherein the fatty acid is derived from natural oils.

37. The process of claim 36 wherein the natural oils are selected from soybean oil, palm oil, olive oil, tall oil, castor oil, cotton seed oil, linseed oil, safflower oil, sunflower oil, canola oil, rapeseed oil, jatropha oil, algae oil, corn oil, tung oil, or mixtures thereof.

38. The process of claim 37 wherein the natural oils are selected from soybean oil, linseed oil, canola oil, tall oil or mixtures thereof.

39. The process of claim 35, wherein the at least one viscosifier is an epoxidized fatty acid ester, and the fatty acid is derived from animal fats selected from beef, mutton, pork, dairy, poultry fat or mixtures thereof.

40. The process of claim 39, wherein the animal fats are selected from suet, tallow, lard, bacon, fatback, butter, poultry fat, schmaltz, blubber or mixtures thereof.

41. The process of claim 35 wherein the fatty acids derived from natural oils or animal fats are substantially fully esterified with monohydric alcohols selected from methanol, ethanol, n-propanol, isopropanol, butanol, pentanol, hexanol, cyclohexanol, octanol, n-octanol, iso-octanol, 2-ethylhexanol, nonanol, neodecanol, decanol, undecanol, dodecanol, tetradecanol, cetyl alcohol, stearyl alcohol, docosanol, epoxidized prop-2-3n−1-ol or mixtures thereof.

42. The process of claim 35 wherein the fatty acids derived from natural oils or animal fats are substantially fully esterified with polyhydric alcohols selected from glycols, glycerols, glycerol mono-acetate, pentaerythritol or mixtures thereof.

43. The process of claim 35 wherein the fatty acids contain unsaturation.

44. The process of claim 35 wherein the epoxidized fatty acid esters are selected from epoxidized 2-ethylhexyl tallate, epoxidized 2-ethylhexyl soyate, epoxidized octyl tallate, epoxidized octyl soyate, epoxidized octyl oleate, epoxidized methyl soyate, epoxidized ethyl soyate, epoxidized soybean oil, epoxidized linseed oil or mixtures thereof.

45. The process of claim 44 wherein the epoxidized fatty acid ester is selected from epoxidized 2-ethylhexyl tallate, epoxidized 2-ethylhexyl soyate, or epoxidized soybean oil.

46. The process of claim 45 wherein the epoxidized fatty acid ester is epoxidized soybean oil.

47. The process of claim 35 wherein the at least one viscosifier is added in an amount from 10.0 to 20.0 wt % based on the weight of the drilling fluid.

48. The process of claim 35 further comprising at least one non-epoxidized fatty acid ester.

49. The process of claim 48 wherein the non-epoxidized fatty acid ester is selected from 2-ethylhexyl tallate, 2-ethylhexyl soyate, octyl tallate, octyl soyate, octyl oleate, methyl soyate, ethyl soyate, soybean oil, linseed oil or mixtures thereof, wherein a ratio epoxidized fatty acid ester/non-epoxidized fatty acid ester is 0.003 to 2.93.

50. The process of claim 49 wherein the ratio epoxidized fatty acid ester/non-epoxidized fatty acid ester is 0.326 to 0.733.

51. The drilling fluid of claim 1 further comprising at least one surfactant.

52. The process of claim 35 further comprising at least one surfactant.
